(19) United States
(12) Patent Application Publication
(10) Pub. No.: US 2013/0174040 A1
(43) Pub. Date: Jul. 4, 2013

(54) METHODS, APPARATUS AND SYSTEMS FOR GENERATING, UPDATING AND EXECUTING A CROP-PLANTING PLAN

(71) Applicant: Jerome Dale Johnson, Waterville, MN (US)

(72) Inventor: Jerome Dale Johnson, Waterville, MN (US)

(21) Appl. No.: 13/341,753

(22) Filed: Dec. 30, 2011

(51) Int. Cl. G06F 3/01

(52) U.S. Cl. 715/733

(57) ABSTRACT

Crop-planting plans may be generated with crop-planting information received from a variety of sources, such as a user, remote sensor, database, and/or data feed. The crop-planting plans may dynamically aid farmers and other production agriculture professionals when determining a crop-planting strategy and implementing a crop-planting plan. Crop-planting plans may include a variety of recommended crop-planting practices and projected outcomes for the implementation of the recommended crop-planting practices.

### FIELD OF THE INVENTION

The present invention relates to methods, graphical user interfaces (GUI), computer-readable media, data, and systems for dynamically generating, updating, and executing a crop-planting plan.

### BACKGROUND

Typically, farmers intuitively determine their planting strategies based on available resources, past experiences, local knowledge, and opinions. In some instances a farmer may hire a consultant or a supplier to assist in the development of a planting plan. However, these practices often result in outcomes that are less than what is possible because they fail to consider many aspects of crop-planting when the farmer makes his or her decisions, including efficient utilization of resources and time available, logistics, including the organization and movement of equipment, people, and supplies, field conditions, field and crop characteristics, constraints, and other factors that contribute to optimizing crop planting, achieving the desired outcomes while managing all relationships. Additionally, intuitive planting strategies are not scalable or measurable for today's large-scale production agricultural businesses that employ large numbers of workers, pieces of equipment, and suppliers, to plant the crops across farms and fields located potentially hundreds of miles apart. In addition, intuitive planting strategies do not leverage all of the data and technical capabilities currently available, such as remote sensing, social networking, or other capabilities that are not known at this time but will certainly become available over time. Intuitive planting strategies do not adapt well to unplanned events such as inclement weather, personnel issues, supply shortages, etc. Also, intuitive planting plans suffer because it is difficult for farmers to modify their traditional habits and practices in the face of broader unplanned events such as those caused by climate changes.

Finally, when planning and executing planting plans, farmers are highly dependent on the performance of their suppliers as they provide and deliver the products and services necessary to achieve the desired planting outcomes. Farmers are also dependent on the buyers of their products who have may requirements for the resulting crop which may need to be considered with planting the crop. Farmers also dependent on the performance of consultants whose services can only be as good as the information with which they are provided. In addition, farmers have landlord responsibilities including contractual obligations. Coordination and communication with these suppliers, buyers, consultants, and landlords is very important yet difficult today, and, other than the use of some rudimentary techniques, are manual in nature and cannot take into account ongoing changing and unplanned-for events.

### SUMMARY

Methods, apparatus, and systems for generating, updating, and executing a crop-planting plan are herein discussed. Information regarding crop planting may be received from a variety of sources, such as a user, a database, a data feed, a social network, a piece of equipment used to execute a portion of the crop-planting plan, and/or a remote sensor via a communication network, such as the Internet, a cloud computing network, a local area network (LAN), a wide area network (WAN), or a wireless LAN (WLAN), and/or a computer-implemented social network (e.g., FaceBook™, Linkedln™, etc.). The received information may include, for example, information regarding a planned event, an unplanned event, a contractual requirement, resource utilization, a crop requirement, a planting requirement, local knowledge, operational profitability, resource availability, remotely sensed information, information received via a resource, and/or information received via a computer-implemented social network.

The received information may be used to generate one or more crop-planting plans. Crop-planting plans may include, for example, buyer, supplier and landlord contractual obligations, a logistics plan that provides logistical options and instructions for the schedule, movement, and use of equipment, supplies, and resources available for the execution of the crop-planting plan. It may also include a sequence of fields to be planted, site specific planting recommendations and instructions, recommended seed planting rates and maturities, recommended nutrition applications, recommended pest control, field locations, maps, resources and their responsibilities, equipment to be used and their capacities, landlords, buyers, suppliers, supplies required (e.g., fertilizer, herbicide, insecticide, seed), schedules and activities to be performed. The crop-planting plan may include the status of the portion of the crop-planting plan that has been already completed, including supplies consumed, supply shortages, capacity utilization, and accomplishments. In one embodiment, a crop-planting plan may include measures of plan effectiveness and efficiencies, for example, a utilization index, a crop index, a time index, a cost index, a capacity rating, and recommendations to improve the indexes. In another embodiment, the crop-planting plan may include a logistics plan that provides logistical options and instructions for the schedule, movement, and use of equipment, supplies, people, and other resources available for the execution of the crop-planting plan.

One or more crop-planting plans may be evaluated according to one or more criterion. A preferred crop-planting plan may then be selected based upon the evaluation. The selected crop-planting plan may then be provided to the user via, for example, the communication network. In some cases, a plurality of crop-planting plans are selected and provided to the user. In other cases, a portion of a crop-planting plan may be provided to a user, an individual employee or other designate of the user, fed directly into the electronic systems of the equipment, and/or into the electronic devices used by the user or other recipients.

In some instances, additional information regarding the selected crop-planting plan may be received from, for example, the user, the manager, the database, the data feed, the equipment, and/or the remote sensor. The additional information may relate to, for example, field condition, weather, market pricing for the crop, equipment availability, operating costs or actual progress or lack of progress to that point in executing the plan. The selected crop-planting plan may then be dynamically updated based upon the received additional information and the updated crop-planting plan may be provided to the user via a communication network.

In one embodiment, the received information may relate to an outcome and a best practice for planting the crop may be determined based on that outcome. In another embodiment, a best practice may be received from, for example, a buyer, supplier, social network, equipment manufacturer, consultant or research organization. The crop-planting plan may then be updated with the determined best practice.

In another embodiment, the crop-planting plans may include multiple attributes or categories of information, such as field condition, visually entered and/or remotely sensed, and the field's availability and readiness upon which to execute the crop-planting plan, resources including equipment, personnel, and supplies available to execute the crop-planting plan, type of crops to be planted, local knowledge, planned and unplanned events, weather data, crop pricing data, and the like. On some occasions, an attribute of the received information may be determined and the received information may be incorporated into a corresponding attribute of the crop-planting plans. For example, when an attribute of the received information relates to a field condition, it may be incorporated into a corresponding field condition attribute of the crop-planting plan.

On some occasions, the received information may include remotely sensed data including data or images produced by a sensor or images of fields and/or crops. The remotely sensed data or images may be analyzed by, for example, the crop-planting plan generator and the condition of crops or fields may be determined therefrom. A sequence of crop planting locations based on the determined condition of the fields as well as other information may then be incorporated into the crop-planting plan.

In one embodiment, the potential impact of utilizing a particular resource, sequence, activity and/or schedule to execute a portion of the crop-planting plan may be determined and a recommendation may be provided to, for example, the user based upon the determined potential impact.

In some instances, the received information may include climate data, historical weather data, current weather data, and/or predicted weather data and the crop-planting plan may be dynamically updated as current weather data, and predicted weather data is received.

In another embodiment a set of instructions for execution of a portion of the crop-planting plan may be generated and provided to, for example, the user, the manager, the database, the data feed, the remote sensor, and/or a piece of equipment utilized to execute a portion of the crop-planting plan via, for example, a device used by the recipient, such as a mobile phone or GPS device. In some instances, the set of instructions may be specific to the user, the manager, the buyer, the supplier, the landlord and/or the piece of equipment utilized to execute a portion of the crop-planting plan. The instructions may be expressed and delivered in one or more formats including but not limited to electonic, printed, bar code and the like.

In one embodiment, execution of the crop-planting plan may be monitored. In some cases, a status for one or more resources utilized to implement the crop-planting plan may be determined and an alert may be provided to the user responsively to the determined status when, for example, a resource is being under utilized, an activity is not accomplished as per the plan, or a supply of a resource is lower than a threshold supply. In some instances, an impact of utilizing a resource to execute a portion of the crop-planting plan may be determined and a recommendation based upon the determined impact of the utilization may be provided to the user.

Exemplary systems provided herein include a crop-planting plan generator and a user interface communicatively coupled to one another via a communication network. The crop-planting plan generator may be configured to receive information regarding crop planting from, for example, a user, a manager, a data feed, a database, equipment, a social network, and/or a remote sensor. The crop-planting plan generator may also be configured to generate a plurality of crop-planting plans for planting of a crop based upon the received information, evaluate the plurality of crop-planting plans according to one or more criterion, select a crop-planting plan responsively to the evaluation, and provide the selected crop-planting plan to a user interface via a communication network.

The user interface may be configured to receive the selected crop-planting plan from the crop-planting plan generator via the communication network, provide the selected crop-planting plan to the user, receive the information regarding crop planting from the user, and provide the received information regarding crop planting to the crop-planting plan generator. Optionally, the system may further include a database communicatively coupled to the crop-planting plan generator that is configured to store the received information regarding crop planting, the plurality of crop-planting plans, and/or the selected crop-planting plan.

### BRIEF DESCRIPTION OF THE DRAWINGS

The present application is illustrated by way of example, and not limitation, in the figures of the accompanying drawings, in which:

FIG. 1 is a block diagram illustrating an exemplary system having elements configured to design a crop-planting plan, in accordance with embodiments of the present invention;

FIG. 2 is a block diagram illustrating exemplary crop-planting data, in accordance with embodiments of the present invention;

FIG. 3 depicts an exemplary diagram of layered geographic and/or geologic data for an area of land, in accordance with embodiments of the present invention;

FIGS. 4A and 4B illustrate exemplary processes for generating a crop-planting plan, in accordance with embodiments of the present invention;

FIG. 5 illustrates an exemplary process for determining a best practice for planting a crop, in accordance with embodiments of the present invention;

FIGS. 6-14 illustrate various exemplary graphic user interfaces (GUI) that may be used to generate and provide a crop-planting plan to a user, in accordance with embodiments of the present invention; and

FIGS. 15-17A-B illustrate various exemplary graphic user interfaces (GUI) that may be used to generate and provide a crop-planting plan to a user, in accordance with embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DETAILED DESCRIPTION

The present invention integrates various types of data from various sources to generate a crop-planting plan that may be used to dynamically aid farmers and other production agriculture professionals when determining, updating, and executing a crop-planting plan. Crop-planting plans may include a variety of recommended planting practices and projected outcomes resulting from the implementation of the recommended planting practices. In some embodiments, a user may be able to manipulate various aspects of a crop-planting plan in order to hypothetically predict outcomes for implementation of various planting practices. In this way, a user can anticipate what a cost or impact of implementation of a particular planting practice may result in prior to its implementation in the “real world.” This may help the user predict and manage resouces, bottlenecks, constraints, costs, contracts, and risks associated with various crop-planting strategies and practices. A crop planting process may be defined as the process by which a crop is placed in the field and all of the associated activities related to that process, such as preparing the field, fertilizing, planting seed, applying pest control treatments, etc.

In some cases, a crop-planting plan may be designed to include the user's local knowledge or requirements. For example, a crop-planting plan may be designed to incorporate information which is only known at the local level such as the availability or unavailability of a resource, a user-defined preference (e.g., always start on field X), or a contractual obligation such as a buyer or landlord deadline for completing all or part of the crop-planting or crop-harvesting process.

In one embodiment, a crop-planting plan may be broken down or divided into one or more plans that include instructions for executing a portion of the crop-planting plan. On some occasions, a plan may be customized for execution by a particular manager, employee, or group of employees that assist a user in the execution of the crop-planting plan.

In one embodiment the crop-planting plan may include a logistics plan that provides logistical options and instructions for the schedule, movement, activities and use of equipment, supplies, and resources available for the execution of the crop-planting plan.

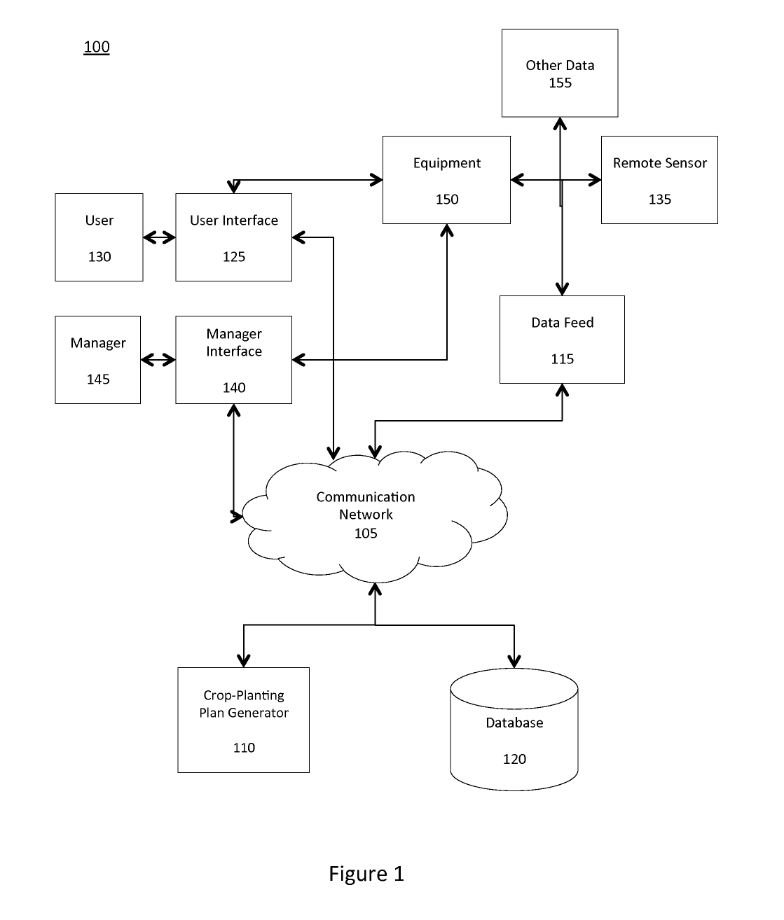

Turning now to FIG. 1, a block diagram depicting an exemplary system 100 for executing one or more of the processes described herein is illustrated. System 100 includes a communication network 105, a crop-planting plan generator 110, a data feed 115, a database 120, a user interface 125, a user 130, a remote sensor 135, a manager interface 140, a manager 145, one or more pieces of equipment used to execute the plan 150, and other data sources 155. Note, in some instances some of these components may be absent from instantiations of the present invention. For example, once crop-planting plans have been generated and deployed, user 130 (e.g., a farmer, manager, or other person or entity involved in the planting of a crop) need not be present. Likewise, users 130 may download crop-planting plans to personal computers, tablet computers, phones, or other portable electronic devices, in which case the crop-planting plan information may be self-contained and access to the communications network and other elements of system 100 may not be required until the crop-planting plan or information concerning crop-planting activities needs to be modified or updated. Thus, system 100 in FIG. 1 is best regarded merely as an example of a system in which the present invention finds application.

As shown, communication network 105 communicatively couples the other elements of system 100 to one another. Exemplary communication networks 105 include cloud computing networks, the Internet, local area networks (LAN), wireless local area networks (WLAN), and wide area networks (WAN). Usually, though not necessarily, user 130 may connect to system 100 periodically, either to upload crop-planting information (e.g., crop-planting plan modifications and additions, accomplishments, outcomes, or unplanned events), download new or updated crop-planting plans, and so on. In some embodiments, multiple users 130 may be enabled to communicate with one another via communication network 105 in a manner similar to, for example, a social network and/or social networking information may be used to generate the crop-planting plan. In some embodiments, crop-planting plan generator 110, may reside on a common computer-based platform, such as a server or set of servers. Such a server may be a physical server or a virtual machine executing on another hardware platform however, the precise nature of such a configuration is not critical to the present invention.

On some occasions, the components of system 100 may communicate directly or indirectly with crop-planting plan generator 110 and/or database 120 via communication network 105. Additionally, equipment 150, other data sources 155, and remote sensor 135 may communicate with crop-planting plan generator 110 and/or database 120 via a communicative coupling to data feed 115 which is coupled to crop-planting plan generator 110 and/or database 120.

Crop-planting plan generator 110 may be configured to generate a crop-planting plan by receiving input from user 130, data feed 115, manager 145, remote sensor 135, accessing data stored in database 120 and/or equipment 150. Data feed 115 may provide remotely gathered data relating to, for example, seed characteristics, weather, climate, geological data and events (e.g., thunderstorms, floods, frosts), supplies including their costs, suppliers, buyers, remotely sensed data. Data feed 115 may be provided by, for example, various public or private sources including free (e.g., US Department of Agriculture or National Oceanic and Atmospheric Administration) and/or fee based entities (e.g., Chicago Board of Trade). On some occasions, data feed 115 may be associated with a system used by a supplier, buyer or landlord. In some embodiments, data feed 115 may be associated with a social network. On some occasions, data feed 115 may be provided by a social networking service (e.g., Twitter, Facebook). In this way, one or more users or other suppliers of data may communicate information between one another that may be relevant to a crop-planting plan.

Exemplary remote sensors 135 include drones, aircrafts, satellites, and/or physical sensors to measure, for example, moisture levels, and field conditions for one or more fields included within a crop-planting plan. In some embodiments, remote sensors 135 may include remotely controlled drones, manned or unmanned aircrafts, or vehicles that remotely sense or gather crop-planting information, such as field condition.

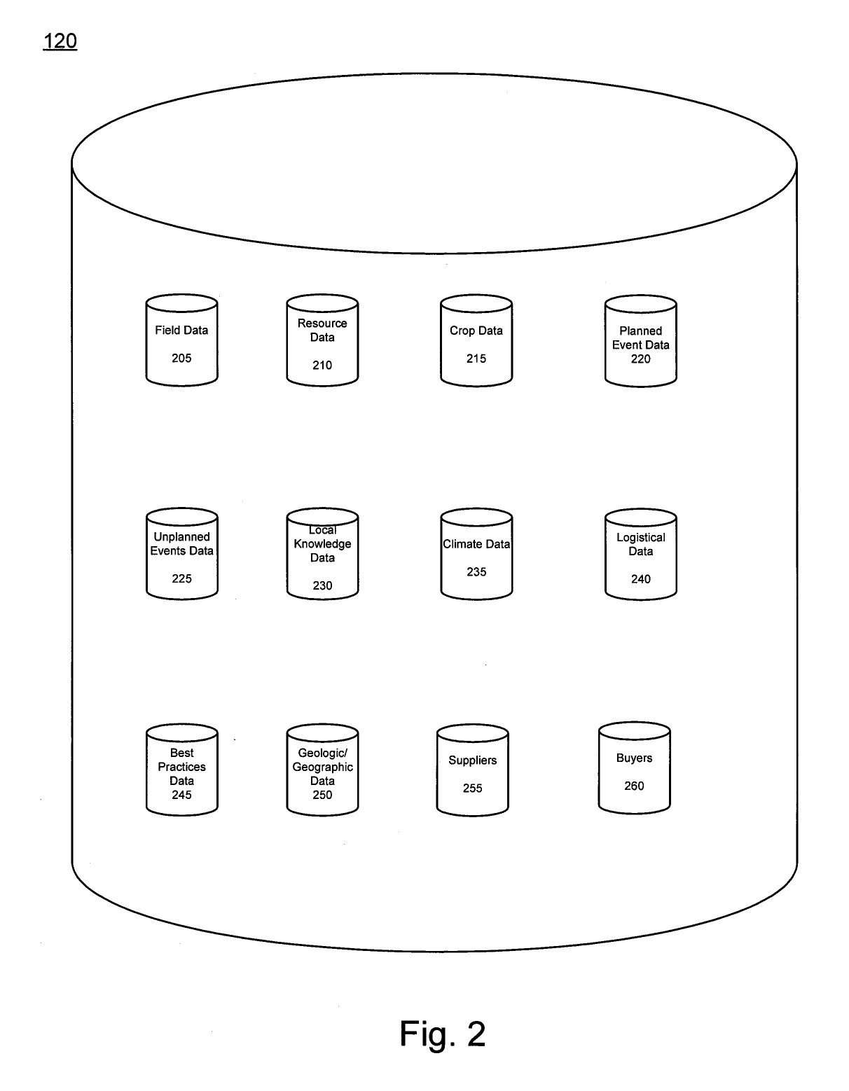

Database 120 may be one or a series of databases linked together and in communication with crop-planting plan generator 110. Database 120 may store data related to any facet of the crop-planting process including, for example, field availability and condition, resource availability or utilization, crop characteristics (e.g., seed type, germination, and/or growth characteristics), unplanned events (e.g., weather, equipment breakdowns, illness and other personnel issues, and changing market prices), local knowledge (e.g., user preferences, user contractual obligations, and historical outcomes), and planned crop-planting events (e.g., personnel availability, tiling, tillage, and fertilizer or pest control application). Further details regarding the information stored in database 120 are discussed below with regard to FIG. 2.

Generating a crop-planting plan can involve the user 130 manually selecting or entering, for example, various preferences (e.g., starting date, targeted end date, starting locations), contracted, legal, and other landlord requirements, end use considerations for a crop, including delivery instructions and locations, contracted, legal, and other buyer requirements, including delivery instructions and locations, field data (e.g., visually determined conditions, features, entry points), equipment type and conditions, transportation and relocation considerations (e.g., weight constraints), employee considerations, and/or crop-planting local knowledge that may be incorporated into a crop-planting plan. On some occasions, manually selected preferences and other user entered information may be stored in database 120.

In some embodiments, a user may enter local knowledge (e.g., preferences) or requirements into crop-planting plan generator 110 for incorporation into a crop-planting plan. For example, a user may enter a period of time in which a particular resource is available or details of a required supply including its delivery and these entries may be incorporated into the crop-planting plan by crop-planting plan generator 110. Alternatively, crop-planting plans may be generated in a partially or wholly automated manner by crop-planting plan generator 110 analyzing, for example, historical, real-time, or known data relating to crop-planting. For example, crop-planting plan generator 110 may automatically include historically known climate conditions (e.g., average temperature or rainfall) for a field or geographic location during a planting and/or growing season into the generation of a crop-planting plan. Of course, many other forms of crop-planting plans can be generated including any type of data related to agriculture or crop-planting.

Once the crop-planting plan is generated, crop-planting plan generator 110 provides information about the crop-planting plan to user 130. This may be done in a variety of ways, including through the use of an e-mail and/or a message relayed via a messaging system accessible through communication network 105 that includes hyperlinks to a portal at which details regarding the crop-planting plan are available. Other forms of communication, such as an instant message or a text message sent via short message service (SMS) to a user's or operator's mobile phone, or an automated phone call placed by the crop-planting plan generator 110, may also be used to, for example, indicate a crop-planting plan has been updated or an unplanned event has occurred. In FIG. 1, user interface 125 is meant to represent any device via which user 130 can be provided with information regarding the crop-planting plan. Exemplary interfaces 125 include computer systems, equipment interfaces as may be provided by, for example, a tractor, planter, and/or other planting equipment, mobile computing devices (including but not limited to so-called “smart phones”), televisions, tablet computing devices, and portable computing devices.

One or more components of system 100 may include a set of instructions stored on tangible and non-transitory computer readable media. The set of instructions may be executed by one or more components of system 100 to perform one or more of the processes described herein. The non-transitory machine-readable storage medium may include a single medium or multiple media (e.g., a centralized or distributed database or data source and/or associated caches and servers) and may include, for example, solid-state memories, optical media, and/or magnetic media.

In some embodiments, one or more managers 145 may be enabled to access a crop-planting plan via manager interface 140 communicatively coupled to network 105. Manager interface 140 may be similar to user interface 125 and, on some occasions, may be resident on a piece of equipment 150 used to execute the crop planting process. Managers 145 may manage and monitor the activities of any number of employees and/or pieces of equipment and the deployment of resources in the planting of a crop or executing a crop-planting plan. Exemplary managers 145 include employees, managers, owners, equipment operators, suppliers, buyers, consultants, landlords, and others who assist user 130 in the planting of a crop or in the completing, updating and/or executing a crop-planting plan.

Crop-planting plan generator 110 may use historical crop-planting information in order to, for example, determine the length of a growing season for planted crops, a period or number of growing degree days required for planted crops to mature, and relative maturities for seeds planted. These determinations may be used to create the crop-planting plan, including making product recommendations as well as predictions for outcomes.

In some embodiments, one or more pieces of equipment 150 will serve multiple functions, including for example, as an input device for the user 130 or the manager 145 for them to modify plans, as an output device for the system to control the activity of the equipment according to the planting crop-planting plan generator's 110 instructions, for example controlling planting rates, seed placement zones, and steering the equipment, and as a status device reporting progress, activities, and outcomes.

In some embodiments, one or more pieces of equipment 150 may be directly and/or indirectly connected to various components of system 100, such as network 105, database 120, remote sensor 135, data feed 115, manager 145, user 130, and/or crop-planting plan generator 110. Exemplary equipment 150 includes vehicles, planters, irrigation equipment, tractors, and other equipment used when planting a crop. On some occasions, equipment 150 may be enabled to provide data such as location, times, and dates of usage, capacity, fuel data, and amount of available seed to, for example, database 120 and/or crop-planting plan generator 110. In some instances, equipment 150 may be enabled to receive a portion of a crop-planting plan and/or other instructions from, for example, user 130, manager 145, and/or crop-planting plan generator 110. For example, equipment 150 may receive instructions enabling or instructing the remote operation of equipment 150. In some embodiments, equipment 150 may include a GUI via which an operator, such as user 130 and/or manager 145 may interact with equipment 150 and/or a component of system 100 coupled to equipment 150.

In other embodiments, one or more other data sources 155 may be directly and/or indirectly connected to various components of system 100, such as network 105, database 120, remote sensor 135, data feed 115, manager 145, user 130, and/or crop-planting plan generator 110. Exemplary other data sources include websites, buyers, suppliers, landlords and other individuals or organizations that may be involved in one or more phases of a crop-planting process.

FIG. 2 is a block diagram depicting exemplary sets of data or databases that may be included in database 120. For example, database 120 may include field data 205, resource data 210, crop data 215, planned events data 220, unplanned events data 225, local knowledge data 230, climate data 235, logistical data 240, best practices data 245, geologic/geographic data 250, supplier data 255, and/or buyer data 260. Information stored in database 120 may be received from, for example, a user, such as user 130, a data feed, such as data feed 115, a manager, such as manager 145, a piece of equipment, such as equipment 150, and/or a remote sensor, such as remote sensor 135 via a communication network, such as communication network 105.

Field data 205 may store information regarding, for example, field locations, the shape of the field, the proximity of fields to each other, the proximity of fields to relevant locations, a user's practices regarding a field (e.g., tillage or crop-planting methods), and field characteristics, such as topographical information, soil type, organic matter, yield capacity, moisture capacity, pH and fertility. In addition, field data 205 may include historical experiences, observations, and outcomes for a field.

Resource data 210 may store information regarding, for example, resources available for planting crops. Exemplary resource data may include equipment data (capacities, costs, fuel consumption), personnel data (skills, availability, wages and benefits), vehicle data (capacities, costs, fuel consumption), and data related to supplies (type, quantities, locations).

Crop data 215 may store information regarding seed and crop characteristics, including, but not limited to, growing degree day requirements, water requirements, nutrient requirements, date, time, and other conditions at planting time, planned end use of a crop, and disease, drought, or pest vulnerabilities for a type of crop.

Planned event data 220 may store information regarding planned events preceding, during and/or following completion of a crop-planting process. Exemplary planned events may relate to activities such as fertilizer or disease or pest control application and field preparation. Other planned events relate to planned downtime for equipment, planned time-off for personnel, and other events that can be anticipated and planned for.

Unplanned events data 225 may store information relating to unplanned or dynamically changing events that may affect the planting of a crop, such as weather or geologic events, equipment breakdowns or unavailability, unplanned cost changes, personnel issues, supplier and supplies issues, changing availability of supplies, and changing market values for crops. Other unplanned events are events that cannot be anticipated at the time of the creation of the crop-planting plan and occur during the execution of the crop-planting plan and impact outcomes and activities.

Local knowledge data 230 may store information relating to knowledge or preferences specific to a user and may include, for example, preferred farming practices, preferred crop-planting sequences, preferred scheduling, field or site-specific knowledge, and past experience. On some occasions, local knowledge data 230 may be used to override or modify an aspect of a crop-planting plan in a manner similar to application of a rule to the crop-planting plan generation process. On some occasions, local knowledge data 230 may include data received via a social network. On other occasions, contractual requirements, special supplier delivery instructions, special landlord requirements, or special buyer requirements, for example the crop must be delivered to the buyer by a specific date and delivered to a specific location in a specific condition.

Climate data 235 may store information relating to weather and/or climate for a particular region or field.

Logistical data 240 may store information relating to the logistics of executing a crop-planting plan, such as movement of people, equipment, supplies to and from the field, including field to field, supplier to field, field to buyer, and storage to field, including routes, schedules, and special instructions.

Best practices data 245 may store information relating to known, learned or determined best practices for planting a crop. Best practices data may be determined from analysis of, for example, local crop-planting processes, crop-planting plans, actual crop-planting outcomes, recommendations of, for example, educational or governmental agencies or distributors of supplies or equipment and/or a comparison of expected crop-planting yields and actual crop-planting outcomes. On some occasions, best practices data 245 may include data received via a social network.

Geographic/geologic data 250 may include geographic and/or geologic data related to, for example, fields upon which crops are planted, and roads to move supplies, equipment, and people. Exemplary geographic or geologic data may include roadway, surface and/or underground water, and landmark locations. Geographic/geologic data 250 may be derived from a variety of sources, such as satellite images, global positioning information, historical information regarding an area of land, plat book service providers, NGOs, public and private organizations and agencies and the like.

Supplier data 255 may include supplies data (SKUs, quantities, locations, prices) and supplier data (names, locations, services, terms and contractual information), as well as delivery and/or application instructions, and dates.

Buyer data 260 may include buyer data (names, locations), as well as contractual information such as delivery instructions, dates, prices, and other terms.

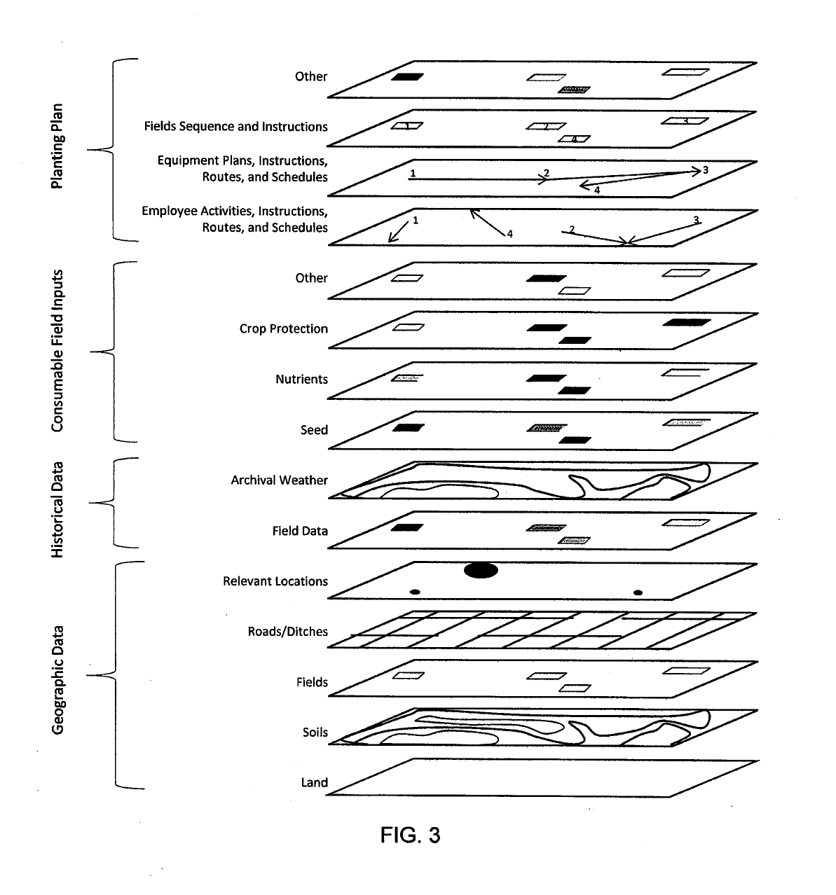

On some occasions, the geographic and/or geologic data 250 may be part of a geographic information system (GIS), an example of which is provided in FIG. 3. As shown, a GIS includes various data structures, each of which may be regarded as a layer. Different layers provide information regarding various aspects of a region, for example, various layers of the GIS may relate to geographic data, historical data, supplies, and a planting plan. Exemplary geographic data may include, for example, information related to an area of land (e.g., size, location, etc.), soil attributes (e.g., soil types, texture, organic matter, fertility, etc.), fields upon the land (e.g., size, shape, location, etc.), any man-made features upon the land (e.g., buildings, roads, ditches, etc.), and relevant locations upon the land of various features (e.g., rock piles, silos, water sources, etc.). Exemplary historical data may include, for example, information related to previously planted crops and climate data. Exemplary supplies may include information related to seeds to be planted and nutrients present in and/or to be applied to a field or land. Exemplary planting plan data may include, for example, information related to employee activities (e.g., employee availability and/or expertise, instructions, transportation routes, and schedules), equipment and/or resource information (e.g., availability, capacity, instructions, transportation routes, and/or schedules) and determinations regarding crops that are planted. Planting plan data may also include field sequence (the order in which the fields will be planted) and/or instructions for the equipment and/or personnel for the planting of seeds and other, miscellaneous information.

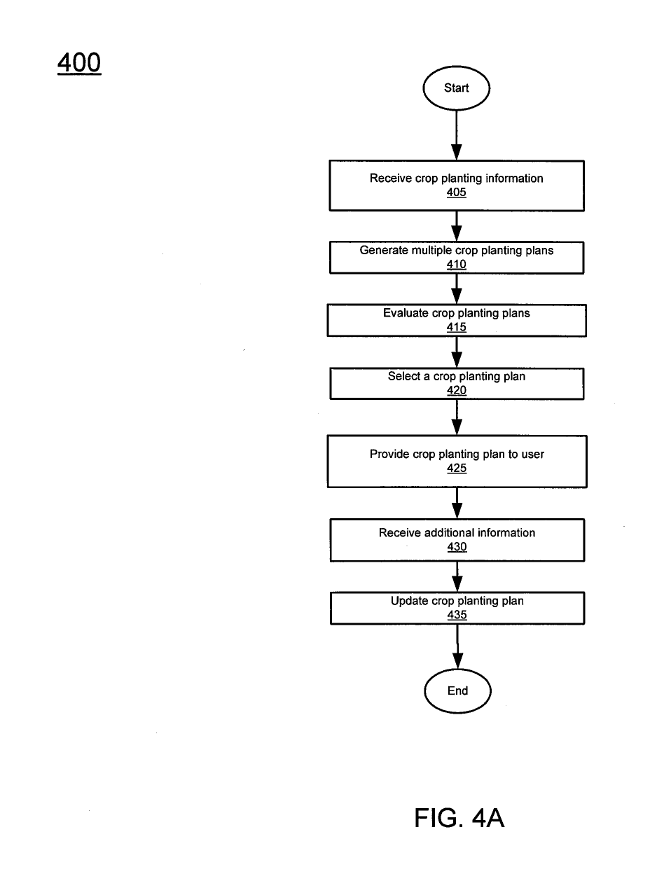

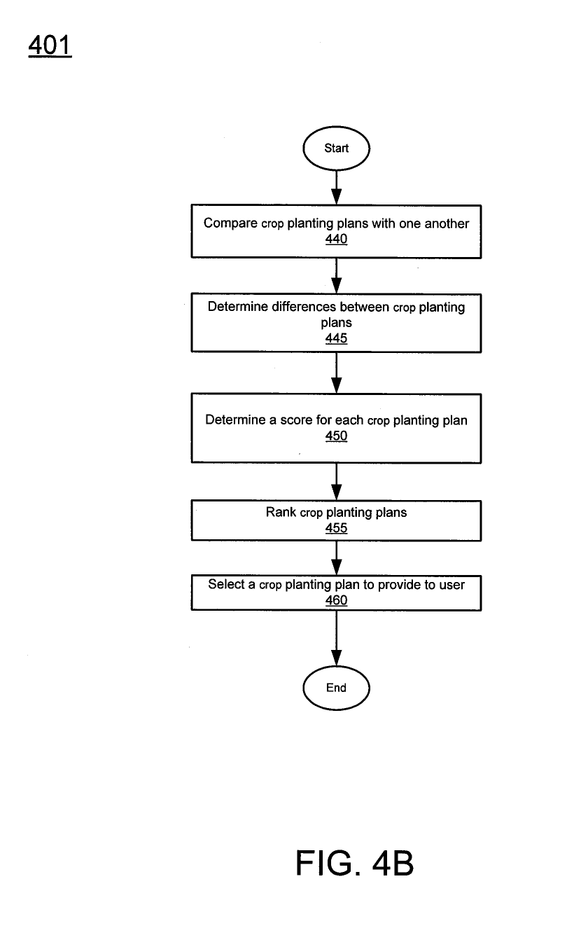

FIG. 4A is a flow chart depicting an exemplary process 400 for generating a crop-planting plan. Process 400 may be executed by, for example, any of the systems and/or system components disclosed herein.

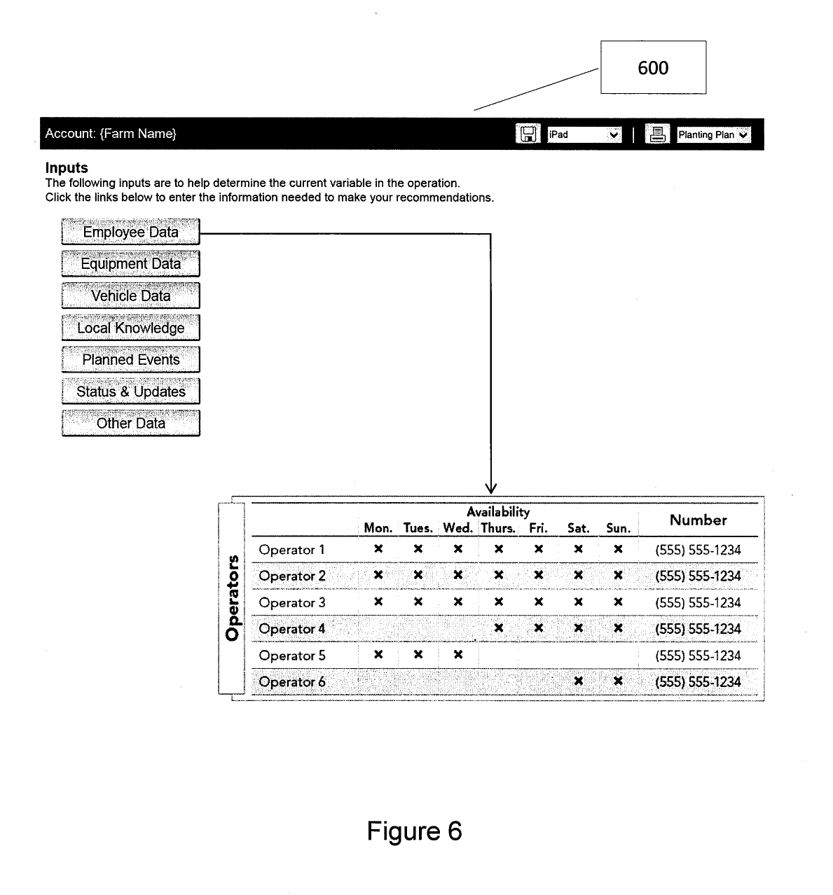

In step 405, information regarding crop-planting may be received by, for example, a crop-planting plan generator, such as crop-planting plan generator 110 from, for example, a user, such as user 130, a database, such as database 120, a data feed, such as data feed 115, a manager, such as manager 145, equipment, such as equipment 150, and/or a remote sensor, such as remote sensor 135 via a communication network, such as communication network 105 and/or an interface, such as interfaces 125 or 140. Exemplary received information may relate to fields or resources for planting crops, crop characteristics, planned events, unplanned events, local knowledge, weather or climate, logistics, crop growing season, the date the crop is planted, crop-planting best practices, human resources considerations, and/or geologic/geographic characteristics of fields or land on which the crop is to be planted. On some occasions, the received information may include one or more previously generated crop-planting plans and/or a best practice associated with an aspect of the crop-planting plan. In some embodiments, a user may provide information regarding crop-planting to the crop-planting generator via a GUI, an example of which is depicted in the screenshot of FIG. 6.

One or more crop-planting plans may then be generated based upon the received information (step 410). When two or more crop-planting plans are generated, each of the crop-planting plans may be evaluated according to one or more criterion (step 415). Exemplary criterion include overall plan efficiency, utilization of resources, financial and/or temporal costs, risks, the suitability of crops to a particular field, potential profit margins for crops resulting from the planted crops, and logistical considerations, including potential bottlenecks and constraints. Then, in step 420, a crop-planting plan may be selected based upon the evaluation and provided to the user via, for example, a communication network (step 425). On some occasions, one or more of the generated crop-planting plans may be provided to the user and, in some instances, the user may select one or more of the crop-planting plans.

In some embodiments, additional information may be received following step 425 (step 430) and the crop-planting plan may be updated to incorporate the additional information (step 435). For example, in step 430, information regarding an unplanned event such as a weather event, equipment breakdown, unavailable personnel, supplier issue, or other conditions may be received and, in step 435, the crop-planting plan may be updated accordingly. The updated plan may then be provided to the user. Following step 435, process 400 may end.

FIG. 4B is a flow chart depicting an exemplary process 401 for evaluating a crop-planting plan as described above with regard to step 415. Process 401 may be executed by, for example, any of the systems and/or system components disclosed herein.

In step 440, one crop-planting plan can be compared to benchmarks and/or two or more crop-planting plans may be compared with one another and/or compared to benchmarks. In some embodiments, this comparison may include a comparison of corresponding attributes of the two or more crop-planting plans. Differences between the crop-planting plans and/or attributes included therein may then be determined based on the comparison (step 445) and a score for each crop-planting plan may be calculated (step 450). In some cases, the score may be an overall score for a crop-planting plan while in other cases sub-scores related to a particular criterion or group of criterions may be determined. The crop-planting plans may then be ranked according to their overall score and/or sub-scores (step 455). One or more crop-planting plans may then be selected for presentation to a user based upon their relative scores or sub-scores (step 460). Following step 460, process 401 may end.

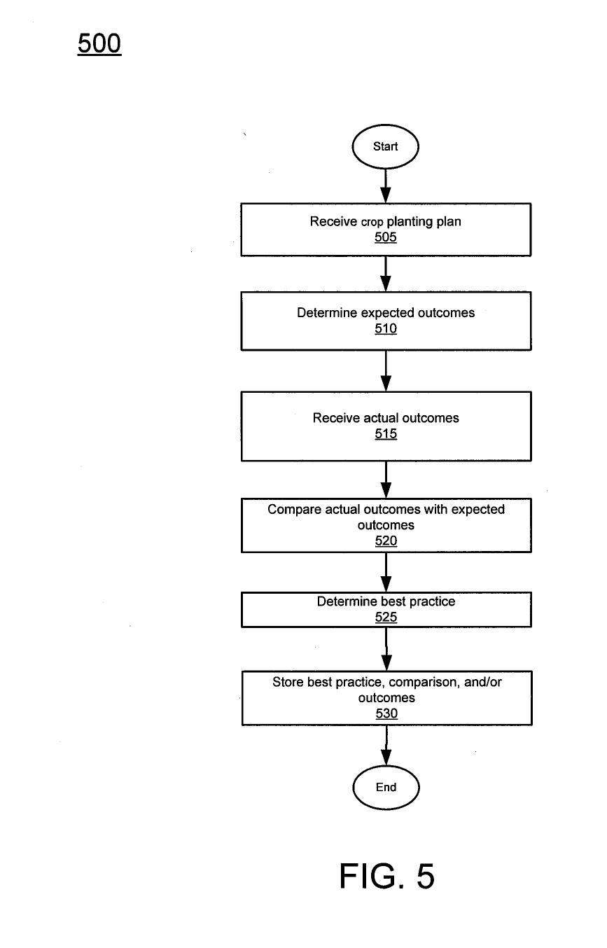

FIG. 5 is a flow chart depicting an exemplary process 500 for determining a best practice for planting a crop. Process 500 may be executed by, for example, any of the systems and/or system components disclosed herein.

In step 505, a crop-planting plan may be received and expected results or outcomes for the crop-planting plan may be determined (step 510). In step 515, information regarding the completed crop-planting plan, such as predicted yield, costs, and efficiencies may be received and compared with the expected results and outcomes for the crop-planting plan (step 520). A best practice may be determined based upon the comparison (step 525) and results of the comparison and/or the determined best practice may be stored in, for example, database 120 (step 530). Following step 530, process 500 may end.

FIGS. 6-17B illustrate various exemplary graphic user interfaces (GUI) that may be used to gather information regarding crop-planting and/or generate and provide a crop-planting plan to a user and/or manager, such as user 130 and/or manager 145. The GUIs of FIGS. 6-17B may be prepared by, for example, crop-planting plan generator 110 and provided to a user, such as user 130 via an interface, such as user interface 125.

FIG. 6 illustrates an exemplary introduction GUI 600 via which a user may input information to be incorporated into a crop-planting plan. For example, GUI 600 enables a user to input, view, and/or modify information regarding employee data, equipment data, vehicle data, local knowledge, planned events, status and updates, and other data, such as that related to buyers and suppliers/supplies. On some occasions, selection of one or more menu items may initiate the display of an interface by which a user may enter planting information. Exemplary interfaces may include a series of questions and text entry boxes into which a user may enter information, or the capability for inputting data through the user interface by another method.

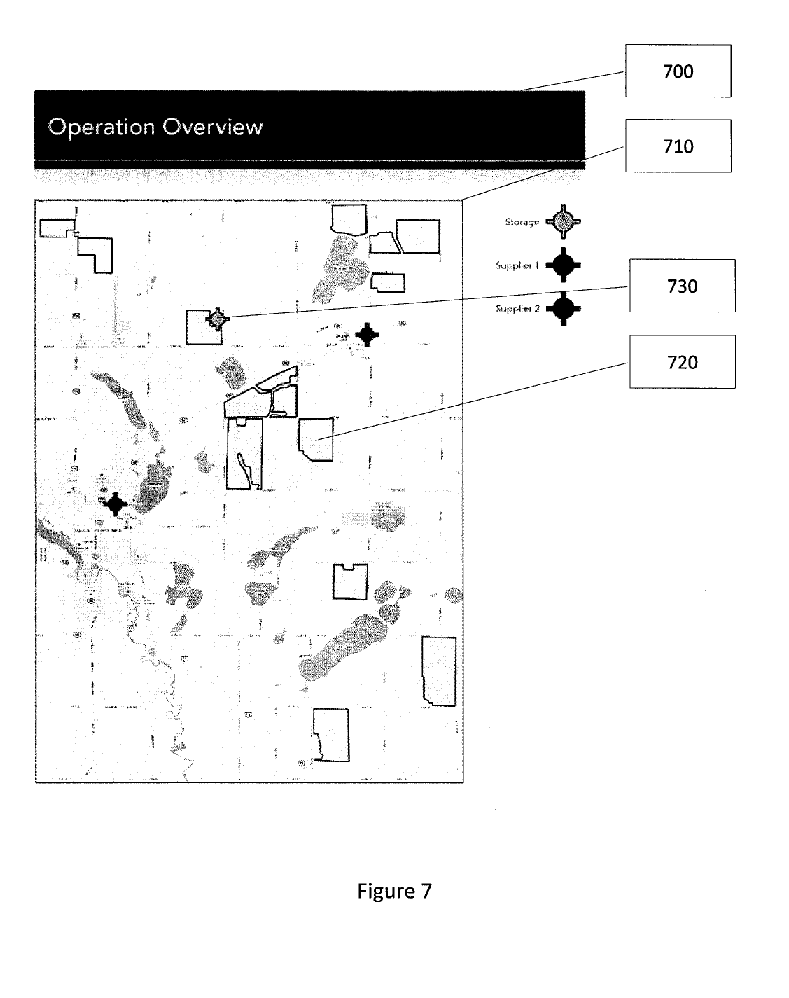

FIG. 7 illustrates an exemplary interactive map GUI 700. Interactive map GUI 700 displays a map 710 of a geographic area. Map 710 may display various geographic and/or geologic features of a region such as roads and bodies of water. Map 710 may also display various fields for the planting of crops 720 and structures 730 that support crop-planting operations such as supply depots, equipment depots, fuel depots, suppliers, landlords other facilities, crop depots, buyer locations, and the like. Their locations, functions, capacities, and other relevant data may be used by crop-planting plan generator 110 to generate a crop-planting plan. In some cases, map 710 may be interactive such that one or more features present on map 710 may act as a link to more information regarding the respective feature. For example, information may be displayed in response to selection of a field 720 or structure 730 provided on map 710 as, for example, a pop-up window or a separate GUI page. In some embodiments, user 130 may select a location or region of land and thereby enter, for example, the function, name, size, or location of, for example, a field, depot, resource, landlord, supplier, or buyer.

In some embodiments, a user and/or operator may enter information (e.g., GPS coordinates, shape, plot number, and/or common names, or address information) to define the location, size, and shape of a field, a feature of a field, a landmark, or resource (e.g., fuel depot, supply depot, equipment depot). Crop-planting plan generator 110 may then use this information to access, for example, one or more databases, such as database 120, data feeds, such as data feed 115, and/or a public or private third party website (e.g., www.noaa.gov, www.usgs.gov, www.usda.gov, www.weather.com) in order to access information regarding the field that may be incorporated into a crop-planting plan. In some situations, the crop-planting plan generator 110 will have previously gathered data from public and private sources, processed and refined, and then optimized and organized the data in database 120 such that when a user enters the location of a field, the crop-planting plan generator 110 may then quickly and automatically access the database 120 to retrieve weather, climate, and geologic data relevant to the field. In some situations, drones or other sensing devices may use the map or information derived from the map to determine from which fields to gather data, determine a flight plan, and control the drone or other sensing device.

On some occasions, information entered via map GUI 700 may be used by crop-planting plan generator 110 to determine one or more transportation routes for supplies, resources and/or equipment. On other occasions, the crop-planting plan generator 110 may use information entered via map GUI 700 to determine information specific to a field or area of land, such as slope, topography, weather, climate, soil types, organic matter present, soil fertility, pH and the like.

On some occasions an interactive or static map which is personalized for an individual, role, piece of equipment, supplier and/or buyer may be create by the crop-planting plan generator 110. The map may include all of the information contained in a complete map or only those aspects relevant to the duties and responsibilities of that person, piece of equipment, supplier or buyer.

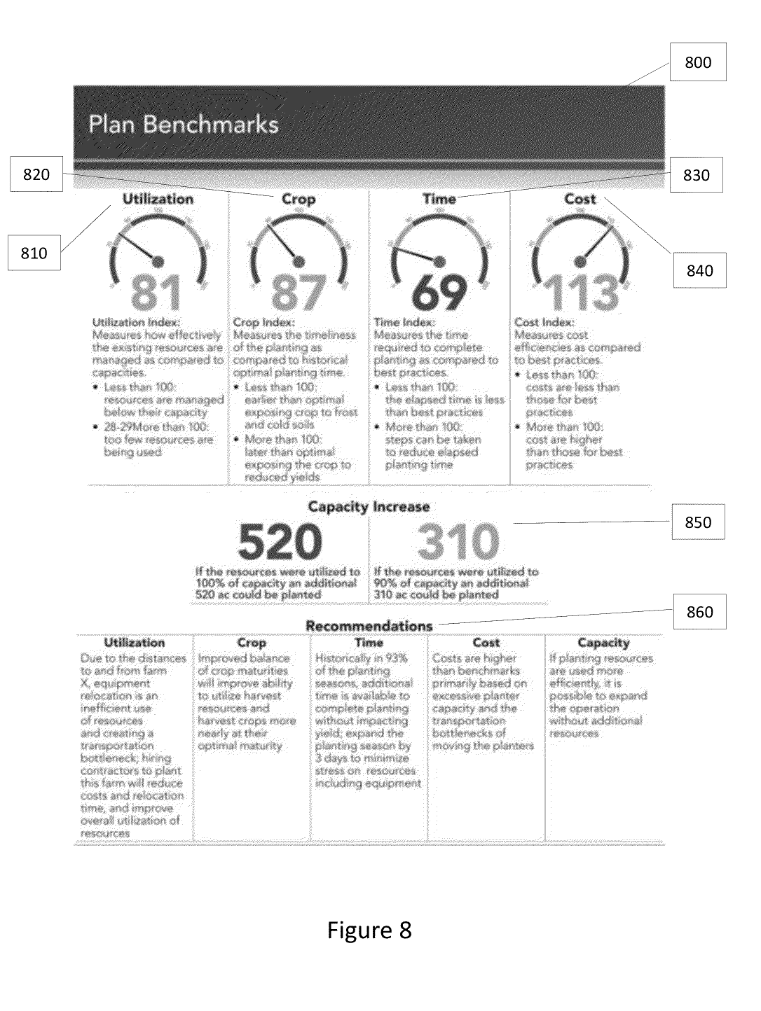

FIG. 8 illustrates an exemplary analysis of crop-planting plan in the form of criterion (index) GUI 800. Crop-planting plan index GUI includes a utilization index 810, a crop index 820, a time index 830, a cost index 840, a capacity measure 850 and a recommendation table 860. The indexes may indicate a numerical value or score for the actual, estimated, and/or projected performance of a crop-planting plan when executed as compared to a benchmark. The indexes can also be used to compare two or more crop-planting plans. In the example provided, indexes 810-840 are structured and calibrated to calculate a score between 0-200. The greater the deviation from the benchmark the further the score diverges from a target score of 100. Of course, any method of measurement or presenting measurement results can be used to generate or provide results from these comparisons.

Utilization index 810 may provide a score indicating how effectively and efficiently the resources available to the user are utilized in the crop-planting plan as compared to their capacities. A score between 0 and 99 may indicate that resources are being, or will be, used below their capacity. A score between 101 and 200 may indicate that too few resources are being or will be used to execute the crop-planting plan, resulting in resources that are used in excess of their capabilities.

Crop index 820 may provide a score indicating a comparison of the field condition when actually planted or scheduled to be planted against the predetermined or predicted optimal field condition and planting time (benchmark). In some examples, a crop benchmark may be a targeted field condition, such as that based on weather, ground temperature, or other conditions. In another example, the benchmark may be a contractual obligation that was defined by a buyer. A score between 0 and 99 may indicate that crops are, or will be, planted earlier than the benchmark. A score indicating an early planting of a crop may indicate the degree to which planted crops may be exposed to frost or cold soils and germination issues. A score between 101 and 200 may indicate that crops are being planted later than the benchmark which may lead to lower crop yields and the risk of a killing frost or other weather events at harvest, and/or the failure to achieve a pricing premium or to meet a contractual obligation. The index could also be used to include a component relating to how the crops will be harvested. For example, it would not be desirable to plant the crop within the target planting window but then have the entire crop all mature at the same time making harvest difficult.

Time index 830 may provide a score indicating a comparison of the elapsed time required to complete crop-planting as compared to a benchmark, or targeted time period. A score between 0 and 99 may indicate that the time planned or actually required to complete the planting a crop is, or will be, less that the known best practices targets. A score between 101 and 200 may indicate that steps can be taken to reduce the total time required to plant the crops and realize a more preferred score.

Cost index 840 may provide a score indicating cost effectiveness of a crop-planting plan. A score between 0 and 99 may indicate that the cost of planting the crop is, or will be, less than known best practices or a targeted costs while a score between 101 and 200 may indicate the opposite.

Capacity increase 850 may indicate that by using resources more effectively the same resources may have the capability to plant crops on additional acres thereby expanding the operation without incurring added costs. For example, if the resources required for the execution of the crop-planting plan associated with crop-planting plan index GUI 800 were utilized at 100% of capacity, an additional 520 acres could be planted while if the same resources were utilized at 90% of capacity, an additional 310 acres could be planted.

On some occasions, GUI 800 may include a recommendation table 860. Recommendation table 860 may include one or more recommendations for modifying the crop-planting plan, resulting in improving one or more indexes 810-840 and/or capacity increase 850. For example, utilization index 810 indicates that the resources available for planting crops are under-utilized because the utilization index is below 100. Thus, recommendation table 860 may provide a utilization recommendation which would result in improving utilization of resources. Recommendation table 860 may also provide a crop-planting recommendation indicating that the crop should be planted later in the season. In some cases, a utilization recommendation may be more specific, such as “due to the distances to and from farm X, equipment relocation is an inefficient use of resources and creating a transportation bottleneck; hiring a contractor to plant this farm will reduce costs and relocation time, and improve overall utilization of resources.” Recommendation table 860 may also provide a crop recommendation indicating, for example, “improved balance of crop maturities will improve ability to utilize harvest resources and harvest crops more nearly at their optimal maturity.”

Recommendation table 860 may further include time, cost, and/or capacity recommendations. An exemplary time recommendation includes “historically in 93% of the planting seasons, additional time is available to complete planting without impacting yield; expand the planting season by 3 days to minimize stress on resources including equipment.” An exemplary cost recommendation includes “costs are higher than benchmarks primarily based on excessive planter capacity and the transportation bottlenecks of moving the planters” and an exemplary capacity recommendation includes “if planting resources are used more efficiently, it is possible to expand the operation without additional resources.”

In one embodiment, recommendation table 860 may include a recommendation for the purchase, renting, or selling of equipment or resources used to plant a crop or execute a crop-planting plan. For example, recommendation table may include a recommendation for the planting of a particular type of crop, fertilizer, insecticide, or herbicide to be used on a field, or a type of equipment that could be used to increase the efficiency of a crop-planting event.

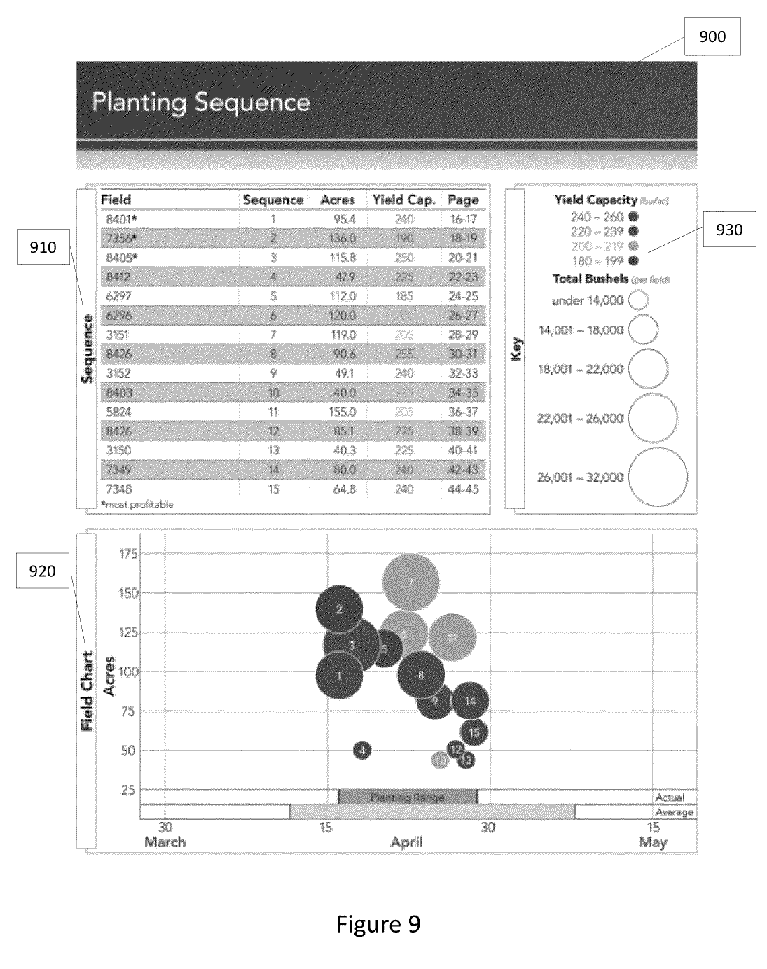

FIG. 9 illustrates an exemplary field detail GUI 900 that includes a sequence table 910, a field chart 920, and a key 930. Sequence table 910 may include a list of multiple fields organized and presented according to a sequence in which they should be planted. The order in which fields are sequenced may be determined by, for example, the crop-planting plan generator in response to and by analyzing information provided to the crop-planting generator. Key 930 may provide a key to the information displayed on field chart 920. Field chart 920 may graphically display, for example, the total acres of land to be planted, the yield capacity or potential rating for a field, the size of a field, and a range of dates and sequence in which a fields are to be planted in relation to the other fields. In this sample embodiment the objective is to plant the fields with the greatest potential for yield and profit at their most ideal time and plant the other fields as per the additional data provided while minimizing unnecessary movement of resources. In some embodiments, the crop-planting plan may be updated to include, for example, completed crop-planting activities. In this scenario a portion of the crop-planting plan has been completed and the remainder is yet to be completed. The plan will reflect this combination of planting completed and planting yet to be completed.

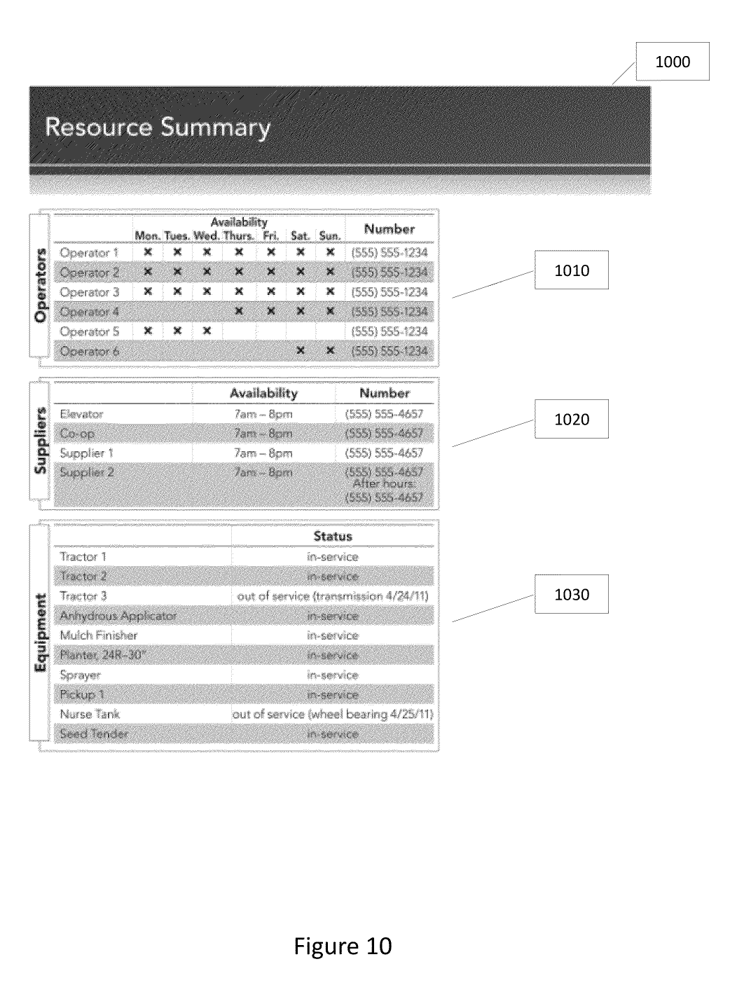

FIG. 10 illustrates an exemplary resources GUI 1000 that includes information relating to equipment and resources available for the planting of crops. For example, resources GUI 1000 may include an operators table 1010, a suppliers table 1020, and an equipment table 1030. Operators table 1010 may include a list of employees or operators, their skills, hours, availability, and contact information. Suppliers table 1020 may include a list of, for example, seed, fertilizer, herbicide, insecticide, equipment, and/or fuel suppliers and their respective availability and contact information. Equipment table 1030 may include a list of crop-planting equipment and its respective status.

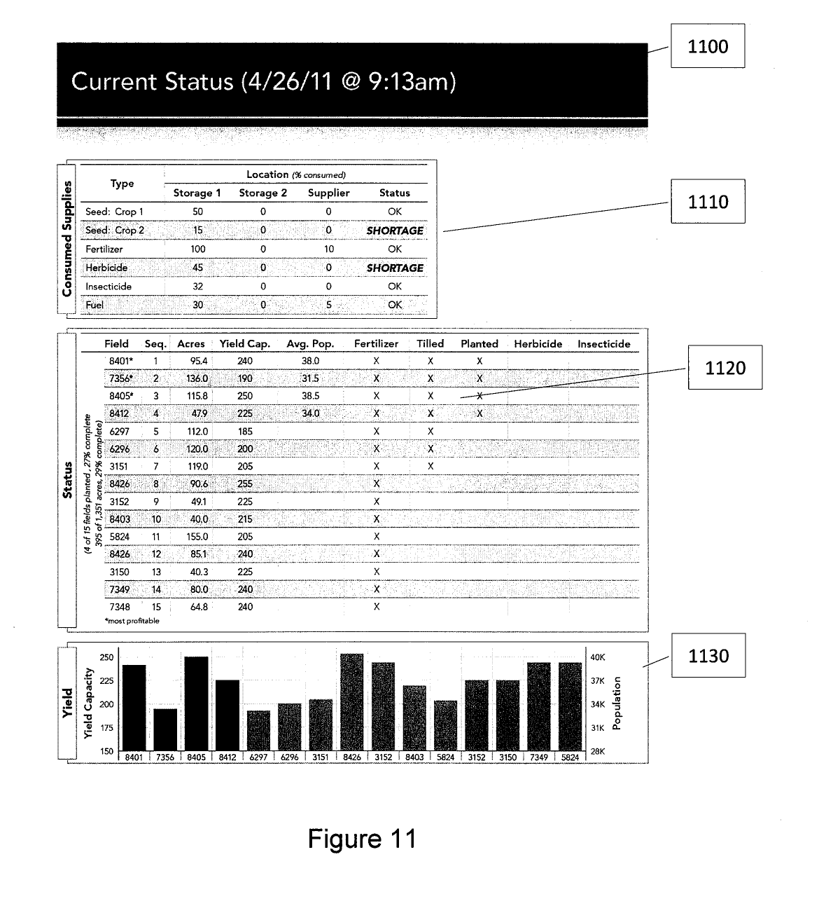

FIG. 11 illustrates an exemplary status GUI 1100 that was created during the crop planting season that provides status for a crop-planting plan. This type of information can provide the user with an overview of the planting activity at any point in time. In this exemplary illustration the crop planting plan has been partially completed and the balance of the plan is yet to be completed. In the upper portion of the example the user has a overview of his or her supplies consumed 1110 including seeds, and other supplies such as fertilizer, herbicide, insecticide, etc., and an indicator of which supplies for which there may be a shortage. Status GUI 1100 may also include a status table 1120 that lists, for example, field names or numbers, planting sequence, field acreage, yield capacity or rating, average seed rate, and the status of a field (e.g., whether a field has been tilled or planted or whether fertilizer, herbicide, or insecticide have been applied to a field). Yield chart 1130 is an example of graphical display of yield capacity and planting sequence. In this example the user can visually review the yield potential of each field and its sequence to be planted.

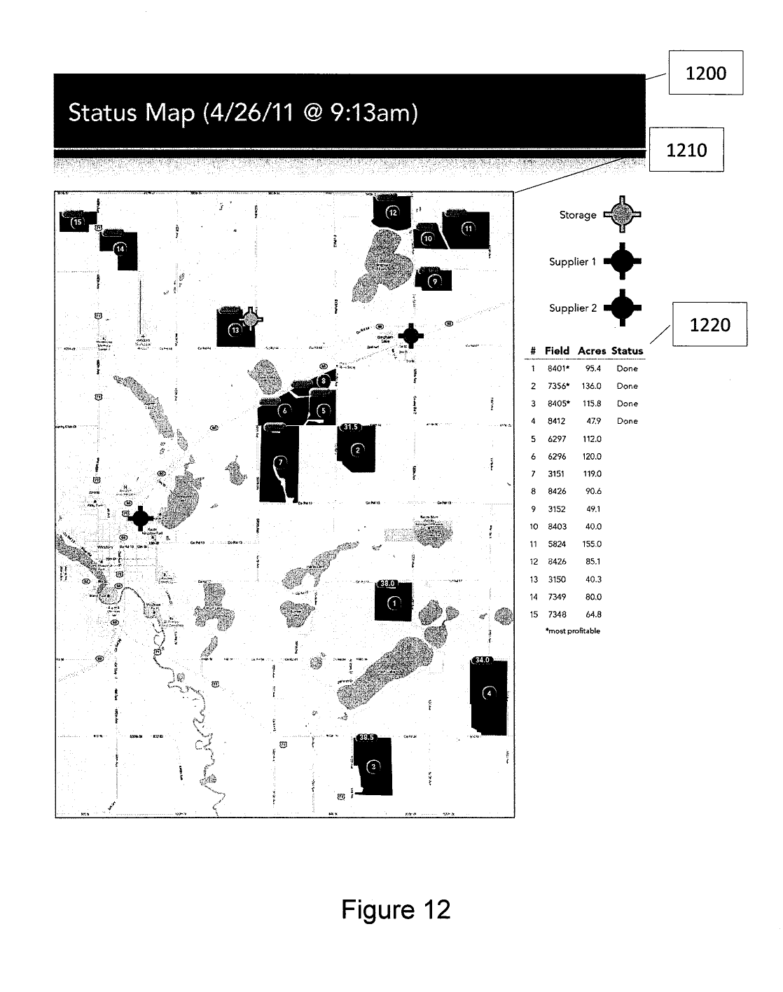

FIG. 12 illustrates an exemplary interactive operational status map GUI 1200. Interactive operational status map GUI 1200 displays a map 1210 of a geographic area. Map 1210 may display an operational status of various crop-planting processes and a table 1220 depicting the acreage and planted seed population of a field. Map 1210 may also include representations of one or more fields. In some embodiments, status map GUI 1200 may be dynamically updated with, for example, updated crop planting information as it becomes available.

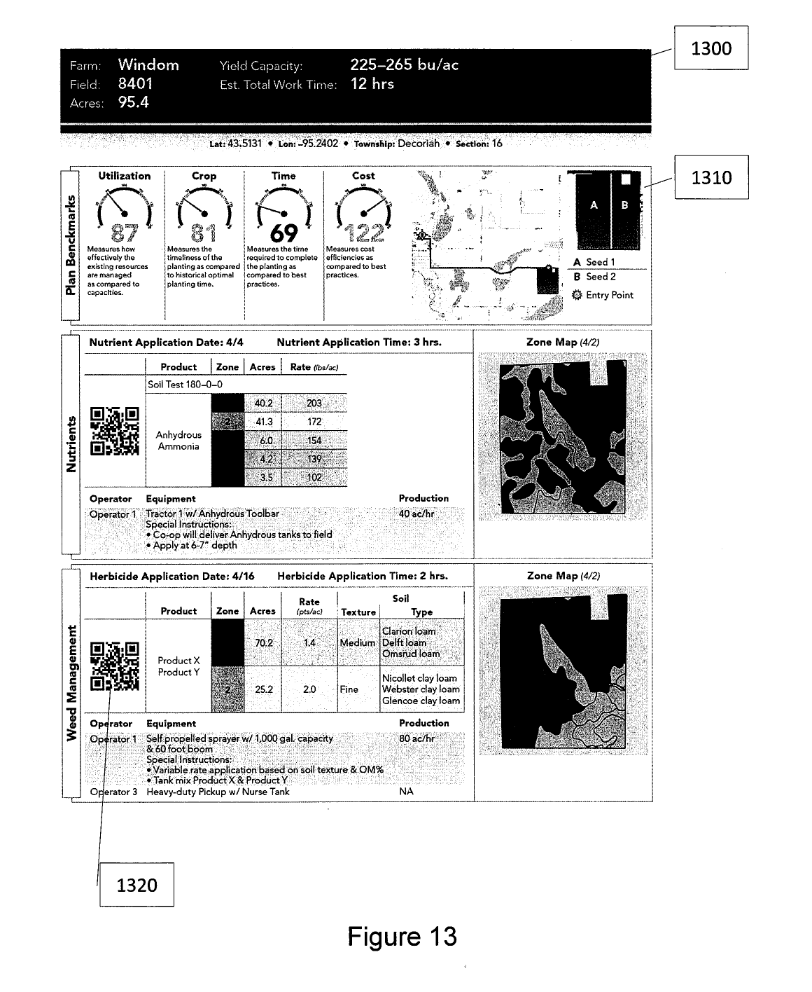

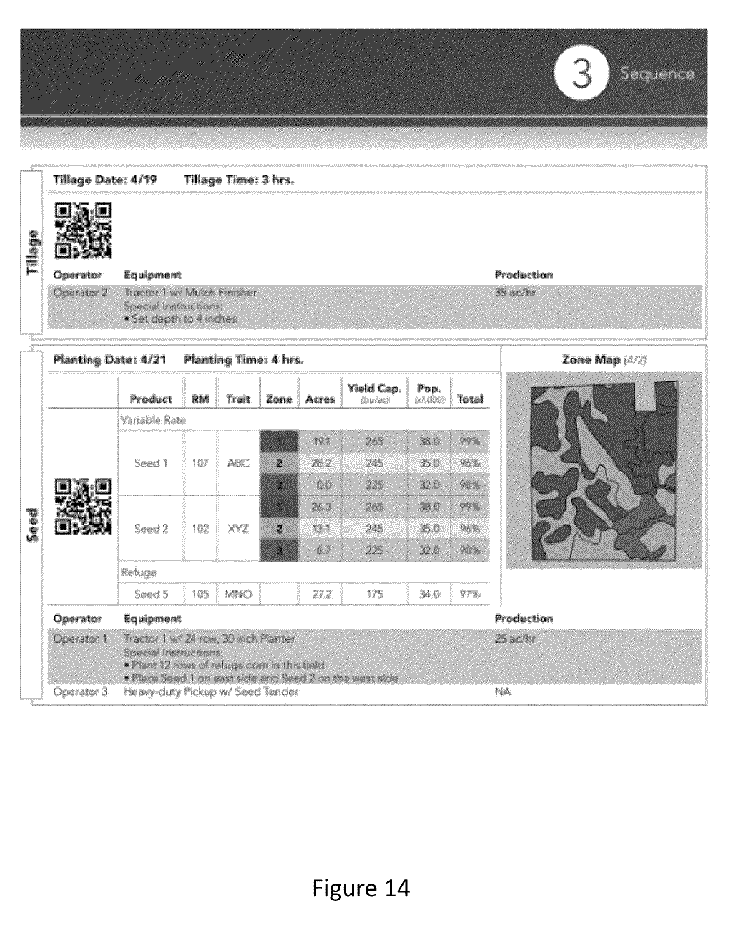

FIGS. 13 and 14 illustrates an exemplary summary GUI 1300 that includes a crop-planting plan for one specific field. This example is site-specific, field-specific. The complete crop-planting plan is a combination of all of these individual field plans. The example GUI 1300 includes the same criterion indexes as those used to measure and benchmark the entire crop-planting plan except they are limited to a specific field. In this embodiment, there are criterion, plans, and instructions that include seed, fertility, pest control and protection, and field preparation (tillage and tiling). All instructions may include a table and map indicating a particular instruction or note for a portion, zone, or the entirety of a field.

The exemplary GUI 1300 contains a map 1310 which illustrates the supplies delivery location as well as the route to transport the supplies to the field. In addition, this map illustrates the type and planting location of the crop(s) and the field entry point. The nutrients, weed management, tillage, and seed portions the exemplary summary GUI 1300 include special instructions and schedules for the these treatments and applications. In some scenarios, these portions may include maps containing management zones that indicate a recommended variable rate of application and treatment in each zone. These zone maps are based on an analysis of weather, imagery, remote sensing, field characteristics, soil types, as well as other data. In another scenario in which the user has a contractual obligation with a buyer, the buyer's terms would also be factored into the algorithm used to calculate the recommended planting rates and other elements of the crop-planting plan. Special instructions for the personnel are also included for one or more equipment operators, and/or employees working in conjunction with user 130 and/or manager 145 to plant crops on this field.

Exemplary summary GUI 1300 also contains machine-readable bar codes 1320. These codes contain all of the instructions necessary for the execution of the crop-planting plan in a form in which the data can be easily directly transferred into the electronic devices used on the equipment including planting and transportation equipment and devices used by the personnel executing the crop-planting plan, buyers, suppliers, and landlords. The bar code used in this example is but one method that can be used to transfer the instructions directly from the crop-planting plan generator 110 into the electronic devices of the equipment, such as equipment 150, used by the personnel. Other methods of transferring instructions include wireless communications, direct information transfer via, for example, a memory stick, or mobile phone.

In some embodiments, crop-planting plans may “broken down” into personalized plans for an individual person or piece of equipment. These plans may be personalized, for example, for one or more equipment operators, and/or employees working in conjunction with user 130 and/or manager 145 to plant crops on the fields. Personalized management plans may be generated and/or customized for execution of some or all of a crop-planting plan and may include specific instructions for an individual including their roles and responsibilities as well as instructions and maps concerning how, when and where to execute a portion of a crop-planting plan. All of the personalized plans may be dynamically updated with, for example, updated crop-planting information as it becomes available. In this embodiment the crop-planting instructions are contained in a machine-readable bar code which provides for a means for the instructions to be electronically transferred directly to the equipment that is executing the crop-planting instructions. While a bar code is used in this embodiment there are numerous methods for the instructions to transferred to the equipment by the Communication Network 105 such as wireless, bar code, memory stick, mobile phone, and the like.

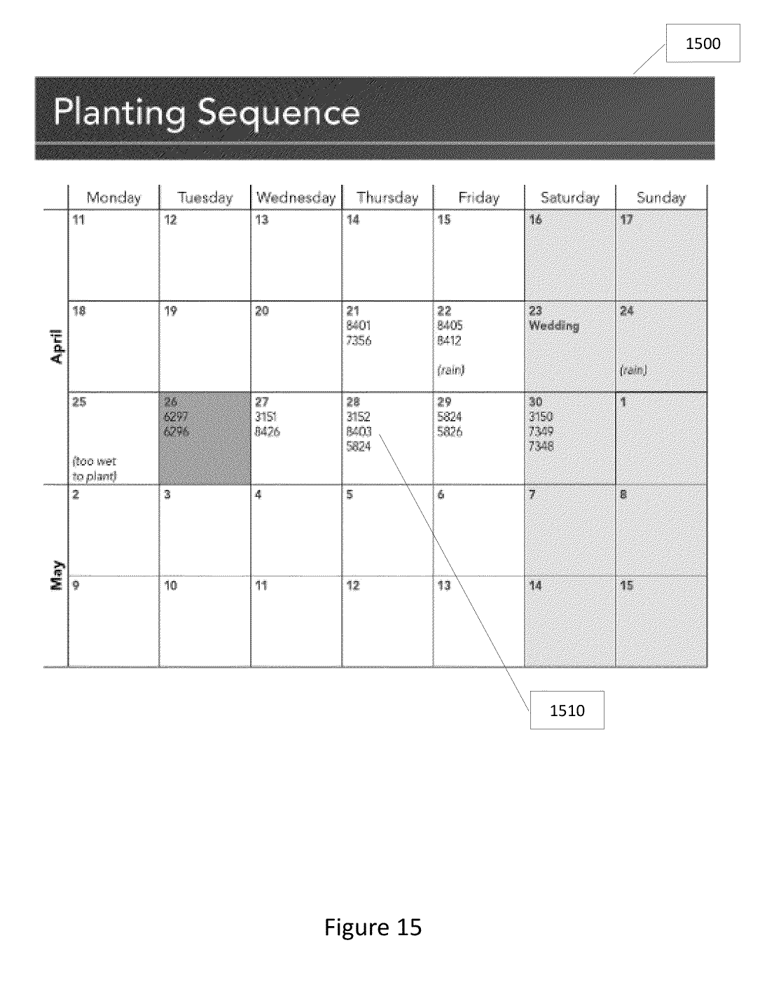

An individualized plan may be provided to user 130, manager 145, equipment operators, and/or employees via, for example a user interface, such as user interface 125 and/or a management interface, such as management interface 140 as, for example, one or more GUIs, examples of which are provided in FIGS. 15-17B. For example, crop-planting sequence GUI 1500, as depicted in FIG. 15, where a schedule or calendar is used to communicate instructions 1510 for tasks to be performed when implementing a crop-planting plan. In some embodiments, user 130, manager 145, an equipment operator, and/or an employee may enter an event or equipment status update and the crop-planting plan may incorporate the new data into the plan. For example, as shown in FIG. 15, a planned event, in this case a wedding has been entered as occurring on Saturday, April 23^{rd} and consequently no crop-planting activity has been scheduled for this individual for this day. Calendar 1510 may also include other planned events, such as deadlines, resource availability, and contractual obligations. In this way, a management and/or crop-planting plan may be customized to accommodate a scheduling need of, for example, user 130, manager 145, an equipment operator, and/or an employee.

Crop-planting sequence GUI 1500 may also provide a sequence of crop-planting activities that are to take place and, on some occasions, the respective dates for doing so. For example, calendar 1510 indicates that crops are to be planted on field 8401 on April 21^{st} and crops are to be planted on field 5824 on April 28^{th} and 29^{th}. Calendar 1510 may also display various other events, such as make-up days or days when no crop-planting activities are scheduled.

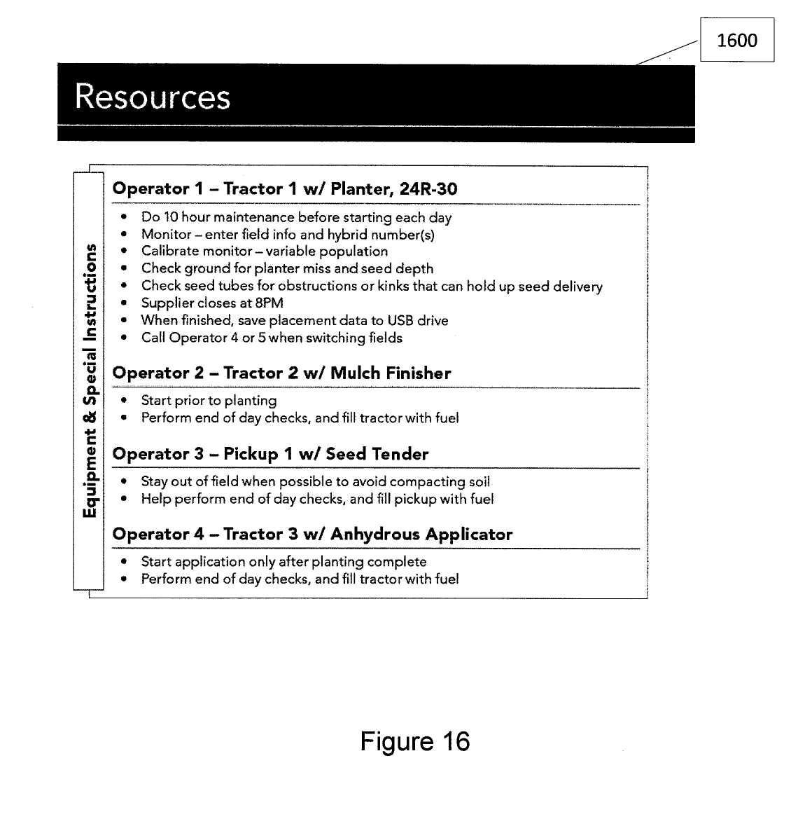

FIG. 16 displays a sample including a summary of instructions for personnel resources GUI 1600 that includes information, instructions, and/or recommendations regarding their activities. For example, resource instruction GUI 1600 may display instructions for a tractor operator, a seed tender, a planter, a truck operator and the like. These instructions reflect the responsibilities and activities of a person or group of people which when all executed properly result in achieving the targeted outcomes.

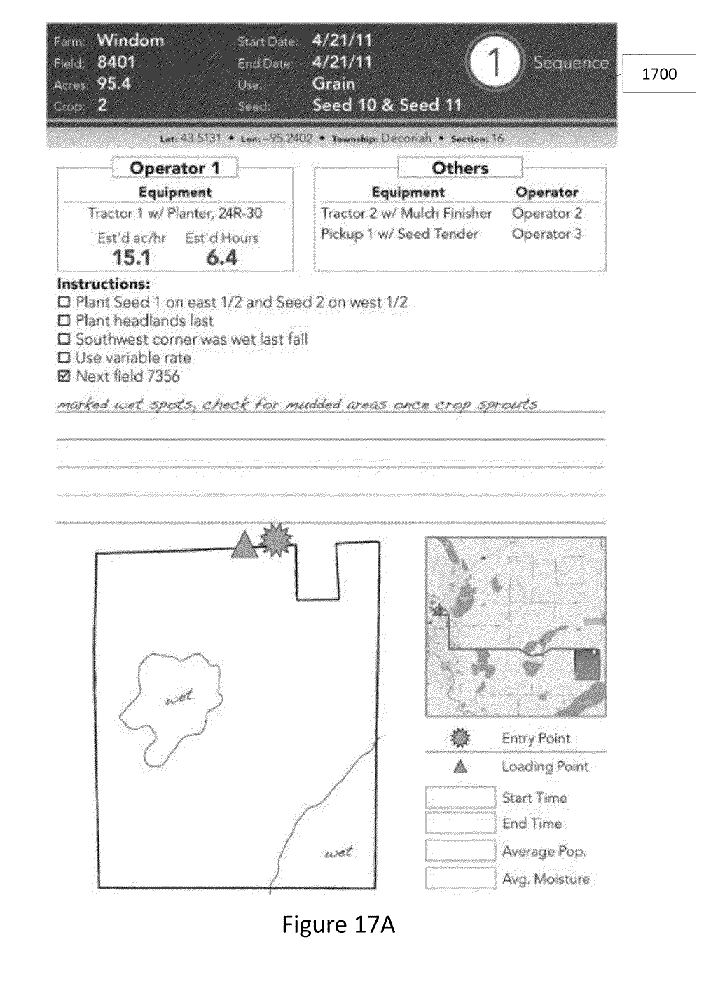

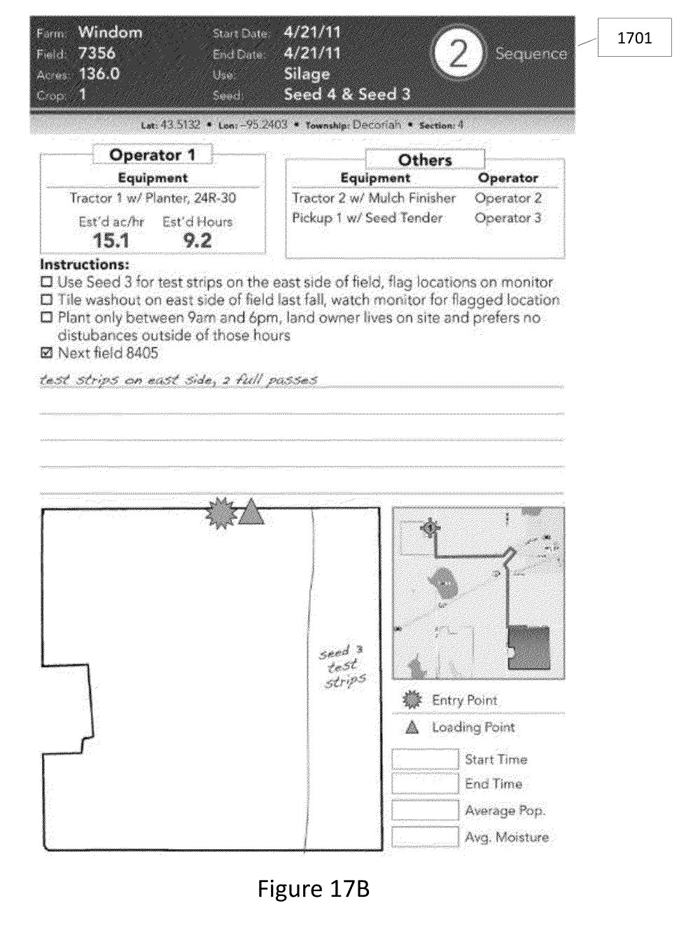

FIGS. 17A-17B display exemplary crop-planting GUIs 1700-1701 for a particular individual and a specific field that may include instructions for the use of equipment available. Crop-planting GUIs 1700-1701 may also include a map, interactive or otherwise, that indicates a location of a field upon which crop may be planted. On some occasions, the map may include details specific to the field, such as areas that are saturated with water or that require special handling.

In some embodiments, field planting GUIs 1700-1701 may include notes or other information entered by, for example, user 130, manager 145, and/or an equipment operator that is planting the crop, such as field location, crop-planting start and end times, planted seed types, population, and other specifics. Other examples are routes for equipment and/or employees to be deployed in order to execute the crop-planting plan.

In some embodiments, crop-planting GUIs 1700-1701 may be provided to user 130, manager 145, and/or an equipment operator as a sequence of instructions which may or may not be field-specific.

Although the exemplary crop-planting plan and management plan discussed with reference to FIGS. 6-17B relate to the planting of a grain, such as corn, it should be understood that the systems, apparatus, and processes disclosed herein may be applied to any type of crops.

Thus, methods, apparatus, and systems for generating a crop-planting plan and updating a crop-planting plan have been herein disclosed.

What is claimed is:

1. A method comprising:
receiving, by a crop-planting plan generator, information regarding planting crops from at least one of a user, a manager, a database, a data feed, and a remote sensor via a communication network;
automatically generating, by the crop-planting plan generator, one or more crop-planting plans for planting crops in one or more fields based upon the received information;
automatically evaluating, by the crop-planting plan generator, one or more crop-planting plans according to one or more criterion;
selecting, by the crop-planting plan generator, a crop-planting plan responsively to the evaluation; and
providing, by the crop-planting plan generator, the crop-planting plan to the user via the communication network.

2. The method of claim 1, further comprising:
receiving, by the crop-planting plan generator, additional information regarding the selected crop-planting plan from at least one of the user, the database, the data feed, and the remote sensor; and
automatically updating, by the crop-planting plan generator, the selected crop-planting plan based upon the received additional information; and
providing, by the crop-planting plan generator, the updated crop-planting plan to the user via the communication network.

3. The method of claim 1, wherein a plurality of crop-planting plans are selected and provided to the user.

4. The method of claim 1, wherein the received information regards a crop-planting outcome, the method comprising:
determining, by the crop-planting plan generator, a best practice for the planting of a crop based on the crop-planting outcome; and
automatically updating, by the crop-planting plan generator, the selected crop-planting plan responsively to the determined best practice.

5. The method of claim 1, wherein the plurality of crop-planting plans include multiple attributes, the method comprising:
identifying, by the crop-planting plan generator, an attribute of the received information; and
incorporating, by the crop-planting plan generator the received information into the identified attribute.

6. The method of claim 1, wherein the received information includes information regarding at least one of a planned event, an unplanned event, a contractual requirement, a crop requirement, a planting requirement, local knowledge, operational profitability, resource availability, remotely sensed information, information received via a resource, and information received via a computer-implemented social network.

7. The method of claim 1, wherein the plurality of crop-planting plans include multiple attributes, the attributes concerning at least one of land available to execute the crop-planting plan, resources available to execute the crop-planting plan, type of crop and seed to be planted, local knowledge regarding crop-planting, planned events, unplanned events, remotely sensed crop and/or field condition, visually sensed crop and/or field condition, and weather data.

8. The method of claim 1, wherein the received information includes remotely sensed data relating to the fields positioned at various locations, the method further comprising:
automatically determining, by the crop-planting plan generator, a condition of the fields positioned at the various locations based upon an analysis of the remotely sensed data; and
automatically determining, by the crop-planting plan generator, a sequence of crop-planting locations based on the determined condition of the fields located thereon; and
automatically incorporating, by the crop-planting plan generator, the sequence of crop-planting locations into the crop-planting plan.

9. The method of claim 1, further comprising;
determining, by the crop-planting plan generator, a potential impact resulting from adding, removing, or altering the utilization of a resource to execute a portion of the crop-planting plan; and
automatically providing an analysis based upon the determined potential impact of the change of the utilization of the resource to the user by the crop-planting plan generator.

10. The method of claim 1, further comprising;
determining, by the crop-planting plan generator, a potential impact resulting from adding, removing, or altering the utilization of a resource to execute a portion of the crop-planting plan; and
automatically providing a recommendation based upon the determined impact of the utilization to the user by the crop-planting plan generator.

11. The method of claim 1, wherein the crop-planting plan includes at least one of a utilization index, a crop index, a time index, a cost index, a capacity rating, a field crop-planting sequence, and recommendations.

12. The method of claim 1, wherein each of the crop-planting plans include a crop-planting logistics plan that provides logistical options and instructions for organizing at least one of resource allocation and resource movement.

13. The method of claim 1, wherein the information is received from a piece of equipment utilized to execute a portion of the crop-planting plan and the crop planting plan is automatically updated by the crop-planting plan generator.

14. The method of claim 1, wherein the received information includes at least one of climate data, historical weather data, current weather data, and predicted weather data, the method further comprising:
automatically updating, by the crop-planting plan generator, the crop-planting plan as climate data, historical weather data, current weather data, and predicted weather data is received.

15. The method of claim 1, further comprising:
receiving, by the crop-planting plan generator, additional information regarding supplier data for at least one of availability, new orders, modified orders, instructions, delivery, and schedules to execute the crop-planting plan; and
incorporating, by the crop-planting plan generator, the supplier data into the crop-planting plan; and
updating, by the crop-planting plan generator, the crop-planting plan as new supplier data is received.

16. The method of claim 1, wherein a portion of the crop-planting plan is provided to a supplier executing a portion of the crop-planting plan via the communication network.

17. The method of claim 1, further comprising:
receiving, by the crop-planting plan generator, additional information regarding the buyer data for at least one of instructions, delivery, and schedules to execute the crop-planting plan; and
incorporating, by the crop-planting plan generator, the buyer data into the crop-planting plan; and
updating, by the crop-planting plan generator, the crop-planting plan as new buyer data are received.

18. The method of claim 1, wherein a portion of the crop-planting plan is provided to a buyer executing a portion of the crop-planting plan via the communication network.

19. The method of claim 1, wherein a portion of the crop-planting plan is provided to a landlord via the communication network.

20. The method of claim 1, further comprising:
monitoring, by the crop-planting plan generator, execution of the crop-planting plan.

21. The method of claim 1, further comprising:
determining, by the crop-planting plan generator, a status for one or more resources utilized to execute the crop-planting plan or an activity included in the crop-planting plan; and
providing, by the crop-planting plan generator, an alert to the user responsively to the determined status.

22. The method of claim 1, further comprising:
generating, by the crop-planting plan generator, a set of instructions for execution of a portion of the crop-planting plan; and
providing, by the crop-planting plan generator, the set of instructions to at least one of the user, the manager, the database, the data feed, the remote sensor, and a piece of equipment utilized to execute the portion of the crop-planting plan.

23. The method of claim 22, wherein the set of instructions is personalized for at least one of the user, the manager, the database, the data feed, the remote sensor, and the piece of equipment utilized to execute the portion of the crop-planting plan.

24. The method of claim 1, further comprising:
providing, by the crop-planting plan generator, at least a portion of the selected crop-planting plan to a manager that assists the user in executing the crop-planting plan via the communication network.

25. The method of claim 1, wherein a portion of the crop-planting plan is provided to a person or resource executing a portion of the crop-planting plan, including an employee, a supplier, a buyer, a landlord or a manager via the communication network.

26. A system comprising:
a crop-planting plan generator configured to receive information regarding crop-planting from at least one of a user, a manager, a data feed, a database, a social network and a remote sensor, automatically generate one or more crop-planting plans for planting a crop in a field based upon the received information, evaluate the crop-planting plans according to one or more criterion, select a crop-planting plan responsively to the evaluation, and provide the selected crop-planting plan to a user interface via a communication network;
the user interface configured to receive the selected crop-planting plan from the crop-planting plan generator via the communication network, provide the selected crop-planting plan to the user, receive the information regarding crop-planting from the user, and provide the received information regarding crop-planting to the crop-planting plan generator; and
the communication network configured to enable communication between the crop-planting plan generator and the user interface.

27. The system of claim 26, further comprising:
a database communicatively coupled to the crop-planting plan generator and configured to store at least one of the received information regarding crop-planting, the plurality of crop-planting plans, and the selected crop-planting plan.

28. The system of claim 26, wherein the communication network is at least one of the Internet, a cloud computing network, a local area network (LAN), a wide area network (WAN), a computer-implemented social network, and a wireless LAN (WLAN).

29. The system of claim 26, wherein the crop-planting plan is further configured to receive additional information relating to a targeted crop-planting outcome and determine a best plan crop-planting based on the received additional information, the system further comprising:
a database communicatively coupled to the crop-planting plan generator and configured to store the plans.

30. A tangible, non-transitory computer-readable media including a set of instructions stored thereon which when executed by a computer enable the computer to receive information regarding crop-planting from at least one of a user, a manager, a database, a data feed, and a remote sensor via a communication network, generate a plurality of crop-planting plans for planting seeds based upon the received information, evaluate the plurality of crop-planting plans according to one or more criterion, select a crop-planting plan responsively to the evaluation, and provide the crop-planting plan to the user via the communication network.
